(19) United States
(12) Patent Application Publication
(10) Pub. No.: US 2007/0038792 A1
(43) Pub. Date: Feb. 15, 2007

(54) SYSTEMS, METHODS, AND COMPUTER PROGRAM PRODUCTS FOR ARBITRATING ACCESS TO A SHARED RESOURCE BASED ON QUALITY-OF-SERVICE INFORMATION ASSOCIATED WITH A RESOURCE REQUEST

(75) Inventor: JongChul Shin, Gyeonggi-do (KR)

Correspondence Address: MYERS BIGEL SIBLEY & SAJOVEC, PO BOX 37428, RALEIGH, NC, 27627, US

(73) Assignee: Samsung Electronics Co., Ltd.

(21) Appl. No.: 11/457,735

(22) Filed: Jul. 14, 2006

(30) Foreign Application Priority Data
Aug. 10, 2005 (KR) 10-2005-0073438

(51) Int. Cl. G06F 13/14

(52) U.S. Cl. 710/240

(57) ABSTRACT

An arbitration system includes at least one shared resource, a plurality of requester units, respective ones of the plurality of requestor units being configured to generate a resource request message for accessing the at least one shared resource, the resource request message comprising quality of service (QoS) information, and an arbitration unit that is configured to prioritize requests for the at least one shared resource based on the QoS information contained in the resource request messages. Related methods and computer program products are also provided.

### RELATED APPLICATION

This application claims the benefit of and priority to Korean Patent Application No. 10-2005-0073438, filed Aug. 10, 2005, in the Korean Intellectual Property Office, the disclosure of which is hereby incorporated herein by reference as if set forth in its entirety.

### FIELD OF THE INVENTION

The present invention relates generally to scheduling requests for a shared resource, and, more particularly, to arbitrating access to a shared resource so as to provide a desired quality-of-service (QoS).

### BACKGROUND OF THE INVENTION

In data processing systems, a resource, such as a system bus, memory bank, or the like, may be shared between several competing requesting devices and/or processes (“masters”) that would like to make use of the resource. As a result, access to such a resource may be arbitrated to determine the order in which each master can access the resource when there are concurrent and/or conflicting requests for the resource. Different masters may have different quality-of-service (QoS) requirements for accessing the resource. Examples of QoS criteria may include data bandwidth and latency. Thus, a resource arbitrator may assign a processor a very high priority for accessing a memory system so as to provide the processor low-latency access to the memory system. As another example, an arbitrator may receive bandwidth on a system bus that can be made available to a video system so that the video screen can be updated as required at a fixed frame rate.

### SUMMARY

According to some embodiments of the present invention, an arbitration system includes at least one shared resource, a plurality of requestor units, respective ones of the plurality of requestor units being configured to generate a resource request message for accessing the at least one shared resource, the resource request message comprising quality of service (QoS) information, and an arbitration unit that is configured to prioritize requests for the at least one shared resource based on the QoS information contained in the resource request messages.

In other embodiments, the QoS information comprises an initial request time and an expected latency time.

In still other embodiments, the QoS information comprises a summation of the initial request time and the expected latency time.

In still other embodiments, the QoS information comprises the initial request time concatenated with the expected latency time.

In still other embodiments, the QoS information further comprises a requested data bandwidth.

In still other embodiments, the plurality of requester units is connected to the arbitration unit through a network.

In still other embodiments, the plurality of requester units is connected to the arbitration unit through the network via a multi-port interface.

In still other embodiments, the plurality of requestor, units is connected to the arbitration unit through the network via a single-port interface.

In still other embodiments, the network comprises a computer network, and/or at least one bus network.

In still other embodiments, the arbitration unit comprises at least one buffer for storing resource request messages from the plurality of requester units.

In still other embodiments, the arbitration unit is further configured to send a grant message to respective ones of the plurality of requester units upon completion of at least a portion of a request associated with the resource request message.

In still other embodiments, the arbitration unit is further configured to send the grant message to respective ones of the plurality of requestor units upon acceptance of the request associated with the resource request message by the at least one shared resource.

In still other embodiments, the arbitration unit is further configured to send the grant message to respective ones of the plurality of requestor units upon completion of the request associated with the resource request message. In still other embodiments, the QoS information comprises an initial request time and an expected latency time. The respective ones of the plurality of requestor units comprise a QoS unit that is configured to generate the QoS information, the QoS unit comprising: latency compensation logic that is configured to determine a compensation value, which is a difference between a time associated with receipt of the grant message and a sum of the initial request time and the expected latency time; and output logic that is configured to add the compensation value to the expected latency time so as to modify the expected latency time for use in a subsequent resource request message.

In still other embodiments, the QoS information further comprises a requested data bandwidth.

In still other embodiments, the output logic is further configured to arithmetically modify the expected latency time using a weight value.

In still other embodiments, the arbitration system further includes a timer that is commonly used by the plurality of requester units and the arbitration unit,

In still other embodiments, the plurality of requestor units and the arbitration unit have a plurality of timers associated therewith respectively.

Although described above primarily with respect to system embodiments of the present invention, it will be understood that the present invention can be embodied as systems, methods, and computer program products.

### BRIEF DESCRIPTION OF THE DRAWINGS

Other features of the present invention will be more readily understood from the following detailed description of specific embodiments thereof when read in conjunction with the accompanying drawings, in which:

FIG. 1 is a block diagram that illustrates an arbitration system according to some embodiments of the present invention;

FIG. 2 is a block diagram that illustrates an arbitration system according to further embodiments of the present invention;

FIG. 3 is a block diagram that illustrates an arbitration system according to still further embodiments of the present invention, FIGS. 4A and 4B are block diagrams that illustrate formats for providing quality-of-service (QoS) information to an arbitration unit in accordance with various embodiments of the present invention:

FIGS. 5A and 5B are timing diagrams that illustrate operations of arbitration systems and methods in accordance with various embodiments of the present invention;

FIG. 6 is a block diagram that illustrates a QoS unit for use in a requester unit in accordance with some embodiments of the present invention;

FIG. 7 is a flowchart that illustrates operations for generating QoS information in accordance with embodiments of the present invention;

FIG. 8 is a flowchart that illustrates operations of arbitration systems in accordance with some embodiments of the present invention; and

FIG. 9 is a block diagram that illustrates an arbitration system according to still further embodiments of the present invention.

### DETAILED DESCRIPTION OF EMBODIMENTS

While the present invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention as defined by the claims.

It will be understood that when an element is referred to as being “connected to” or “coupled to” another element, it can be directly connected or coupled to the other element or intervening elements may be present. In contrast, when an element is referred to as being “directly connected to” or “directly coupled to” another element, there are no intervening elements. As used herein, the term “and/or” and “/′” includes any and all combinations of one or more of the associated listed items. Like numbers refer to like elements throughout the description.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that although the terms first and second are used herein to describe various components, circuits, regions, layers and/or sections, these components, circuits, regions, layers and/or sections should not be limited by these terms. These terms are only used to distinguish one component, circuit, region, layer or section from another component, circuit, region, layer or section. Thus, a first component, circuit, region, layer or section discussed below could be termed a second component, circuit, region, layer or section, and similarly, a second component, circuit, region, layer or section may be termed a first component circuit, region, layer or section without departing from the teachings of the present invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and this specification and will not be interpreted in an idealized or overly formal sense unless expressly so defined herein.

The present invention may be embodied as systems, methods and/or computer program products. Accordingly, the present invention may be embodied in hardware and/or in software(including firmware, resident software, micro-code, etc.). Furthermore, the present invention may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following, an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

The present invention is described herein with reference to flowchart and/or block diagram illustrations of methods, systems, and computer program products in accordance with exemplary embodiments of the invention. These flowchart and/or block diagrams further illustrate exemplary operations in accordance with some embodiments of the present invention. It will be understood that each block of the flowchart and/or block diagram illustrations, and combinations of blocks in the flowchart and/or block diagram illustrations, may be implemented by computer program instructions and/or hardware operations. These computer program instructions may be provided to a processor of a general purpose computer, a special purpose computer, or other programmable data processing apparatus to produce a machine, such that the instructions, which execute via the processor of the computer or other programmable data processing apparatus, create means and/or circuits for implementing the functions specified in the flowchart and/or block diagram block or blocks.

These computer program instructions may also be stored in a computer usable or computer-readable memory that may direct a computer or other programmable data processing apparatus to function/operate in a particular manner, such that the instructions stored in the computer usable or computer-readable memory produce an article of manufacture including instructions that implement the function/operation specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions/operations specified in the flowchart and/or block diagram block or blocks.

Some embodiments of the present invention stem from a realization that it may be desirable to arbitrate access to a shared resource based on quality-of-service information. Moreover, it may also be desirable to ensure that the quality-of-service information incorporates the real latency of a bus and/or computer system network that may connect the requestor to the arbitration unit and/or the shared resource.

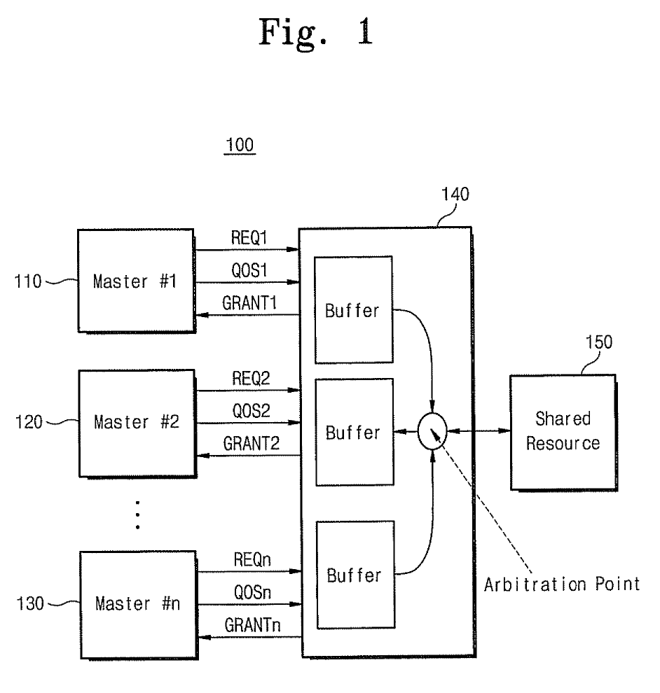

Referring to FIG. 1, an arbitration system, according to some embodiments of the present invention, includes a plurality of master or requester units 110, 120, and 130 that are communicatively coupled to an arbitration unit 140 that is configured to control access to a shared source 150. As shown in FIG. 1, there can be any number of master or requester units 110, 120, and 130. Moreover, although only one shared resource is shown, it will be understood that there may be a single or multiple shared resources 150 in accordance with various embodiments of the present invention.

The master or requestor units 110, 120, and 130 may be configured to generate a resource request message (REQ*) to access the shared resource 150. In some embodiments, the resource request message may include quality-of-service (QoS) information (QoS*) that may include, but is not limited to, an initial request time, an expected latency time, and/or a requested data bandwidth in accordance with various embodiments of the present invention. The expected latency may be, for example, a time for a master or requester unit 110, 120, and 130 to send a request signal to the arbitration unit and receive a GRANT signal in response. In accordance with various embodiments of the present invention, the arbitration unit 140 may send a GRANT message to a master or requester 110, 120, and 130 upon completion of at least a portion of the request associated with the resource request message, upon acceptance of the request associated with the resource request message, or upon completion of the request associated with the resource request message.

The arbitration unit 140 includes one or more buffers that can be used to re-order requests from the master or requester units 110, 120, and 130 based on the priorities assigned to those requests. The arbitration unit 140 may use a single or multiple buffers to service a single or multiple master or requestor units in accordance with various embodiments of the present invention. That is, each master or requestor unit 110, 120, and 130 may be assigned its own buffer, a single buffer may be used to service all of the master or requestor units 110, 120, and 130, or multiple buffers may be used, but not respectively assigned to individual master or requester units 110, 120, and 130. The arbitration unit 140 may prioritize the resource requests based on the QoS information contained in the resource request messages. Thus, the arbitration unit 140 may control access by the master or requester units 110, 120, and 130 to the shared resource 150 by prioritizing the order of resource requests from the master or requester units 110, 120, and 130 based on QoS information associated therewith.

The desired QoS of a master or requestor unit 110, 120, and 130 may be satisfied, for example, if the master or requester unit 110, 120, and 130 receives a GRANT message within the expected latency defined in the QoS information. Because the QoS information may include an initial request time along with an expected latency time, the arbitration unit 140 may take into account the time that may elapse in processing the resource request message before the resource request message ever reaches the arbitration unit 140. If the masters or requestor units 110, 120, and 130 are separated from the arbitration unit 140 by one or more buses, networks, processing units, storage units, and/or the like, then the time that elapses before a resource request message sent from a master or requester unit 110, 120, and 130 reaches the arbitration unit 140 may be significant. Advantageously, the arbitration unit 140 may take such delays into account in prioritizing requests for the shared resource 150 because the QoS information associated with the requests may reflect the real latency of a bus or other system network coupling the master or requester units 110, 120, and 130 to the arbitration unit 140.

The master or requestor units 110, 120, and 130 may each include its own timer or clock and the arbitration unit 140 may also include its own timer or clock. These timers or clocks may be synchronized to ensure that the arbitration unit 140 can prioritize resource requests based on a common time reference. In other embodiments, a single clock or timer may be used throughout the arbitration system.

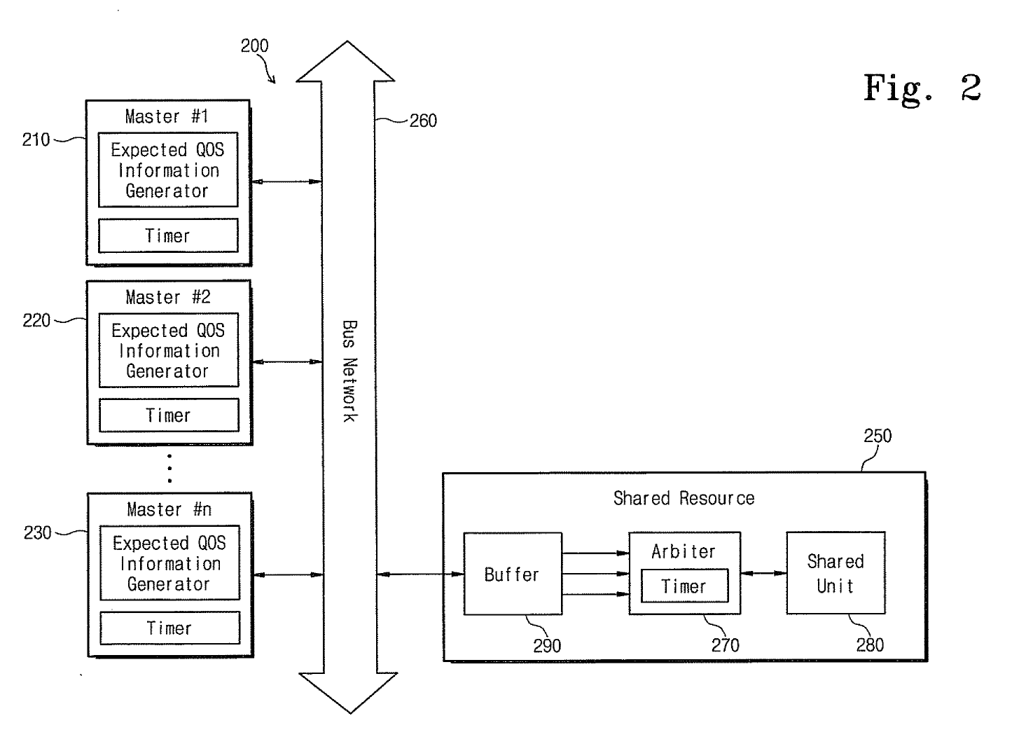

Referring to FIG. 2, an arbitration system 200, in accordance with further embodiments of the present invention, includes a plurality of master or requestor units 210. 220, and 230 that are coupled to a shared resource 250 via a network 260. Each of the master or requestor units 210, 220, and 230 includes a module for generating the QoS information for resource request messages and a timer. In accordance with various embodiments of the present invention, the network 260 may comprise a computer network, at least one bus network, or a combination of a computer network and at least one bus network. In the embodiments illustrated in FIG. 2, an arbitration unit 270 is part of the shared resource 250. It will be understood that in other embodiments, the arbitration unit 270 and buffer can be in separate modules from the shared resource 250. The arbitration unit 270 and master or requestor units 210, 220, and 230 each have their own clocks or timers, which may be synchronized with respect to each other.

As discussed above, because the masters or requestor units 210, 220, and 230 are separated from the arbitration unit 240 by one or more buses, networks, processing units, storage units, and/or the like, the time that elapses before a message sent from one of the master or requester units 210, 220, and 230 reaches the arbitration unit 270 may be significant. Advantageously, the arbitration unit 270 may take such delays into account in prioritizing requests for the shared unit 280 of the shared resource 250 because the QoS information associated with the requests may reflect the real latency of the network 260. Conventional arbitration systems typically use the time that a request reaches the arbitration unit as a start time for determining latency, thereby failing to take into account the real latency, which includes delays associated with the network 260.

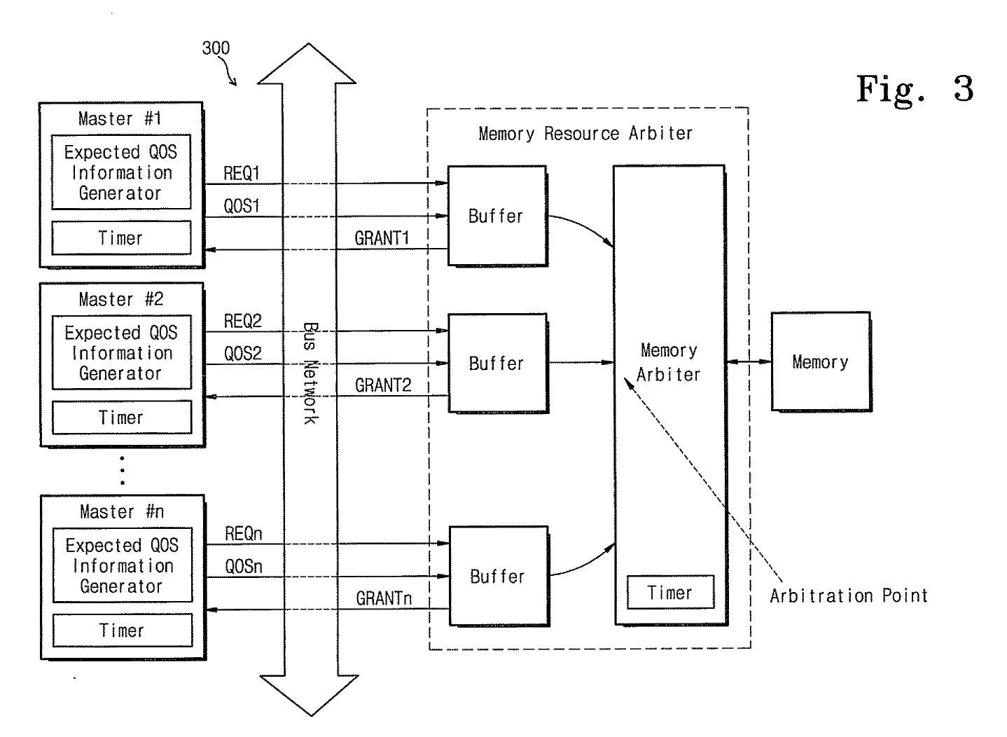

As shown in FIG. 2, a plurality of master or requester units 210, 220, and 230 are connected to the arbitration unit 270 through the network 260 via a single port interface coupled to a single buffer 290. In other embodiments of the present invention, FIG. 3 illustrates an arbitration system 300 in which a plurality of requestor or master units are connected to an arbitration unit through the network via a multi-port interface coupled to a plurality of buffers. The various components of the arbitration system of FIG. 3 and operations thereof are similar to those of the arbitration systems of FIGS. 1 and 2. Although FIG. 3 illustrates an arbitration system for arbitrating access to a memory, it will be understood that the present invention is not limited to such applications, but can instead be embodied generally without regard to the nature of shared device or process.

FIGS. 4A and 4B are block diagrams that illustrate formats for providing QoS information to an arbitration unit in accordance with various embodiments of the present invention. As shown in FIG. 4A, the initial request time and expected latency may be summed when providing the QoS information to the arbitration unit. In other embodiments shown in FIG. 4B, the initial request time and expected latency may be concatenated when providing the QoS information to the arbitration unit.

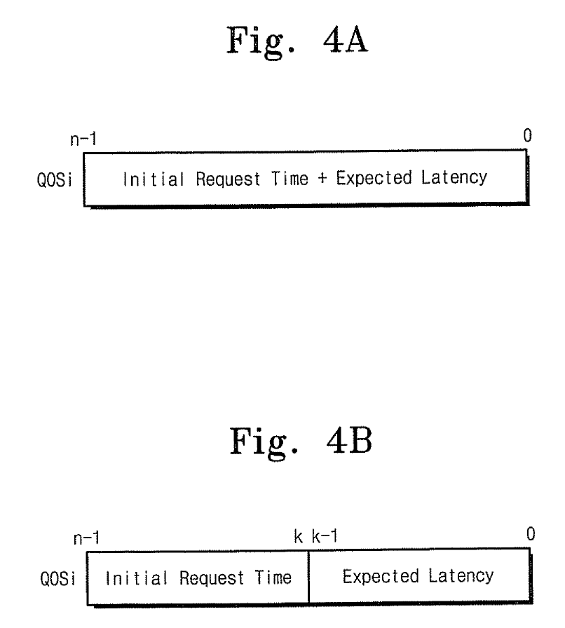

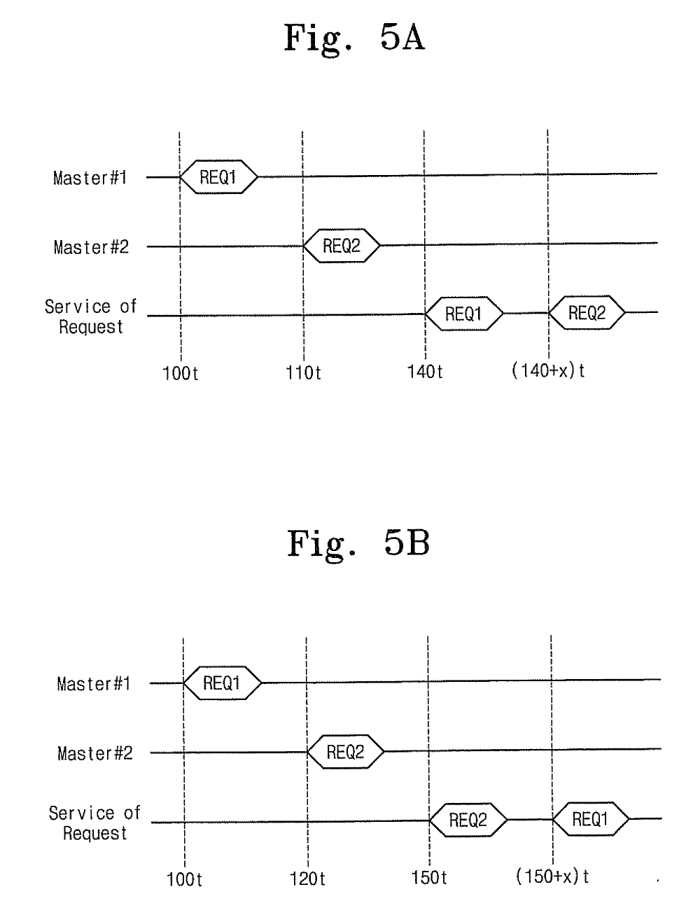

Operations of arbitration systems and methods, according to some embodiments of the present invention may be illustrated by way of example. FIGS. 5A and 5B are timing diagrams that illustrate operations of arbitration systems and methods in accordance with various embodiments of the present invention. Referring to FIG. 5A, time is represented in units of clock cycles t. A timer is reset to be clock cycle 0t and the time increments each clock cycle. At time loot, a master or requester 1 sends a resource request message to an arbitration unit including QoS information with respect to expected latency being 50t. A second master or requester sends a resource request message to the arbitration unit at time 110t. The QoS information in the second resource request is that the expected latency should also be 50t. Although sent second, the resource request message from the second master or requestor reaches the arbitration unit at 120t while the resource request message from the first master or requester reaches the arbitration unit at 130t. The maximum service time limit for the request from the first requester is 150t (initial request time plus expected latency) while the maximum service time limit for the request from the second requester is 160t. Thus, the arbitration unit determines at time 140t to grant the request of the first requester before the request of the second requestor because the request of the first requestor has less time before reaching the service time limit.

Referring now to FIG. 5B, in this example, the first master or requester sends a resource request message at time 100t with an expected latency of 70t, which results in a maximum service time limit of 170t for the arbitration unit. The second master or requestor sends a resource request message at time 120t with an expected latency of 20t, which results in a maximum service time limit of 140t. The arbitration unit receives the request from the first master or requester at time 110t and the request from the second master or requester at time 140t. The arbitration unit at time 150t determines to grant the request of the second requestor because that request has already timed out at time 140t and has higher priority than the request from the first master or requester even though the request from the first master or requester was received first at the arbitration unit.

Note that the value “x” shown in FIGS. 5A and 5B indicates that the start time for servicing a subsequent request is not fixed because it depends on the time needed to complete a previous request.

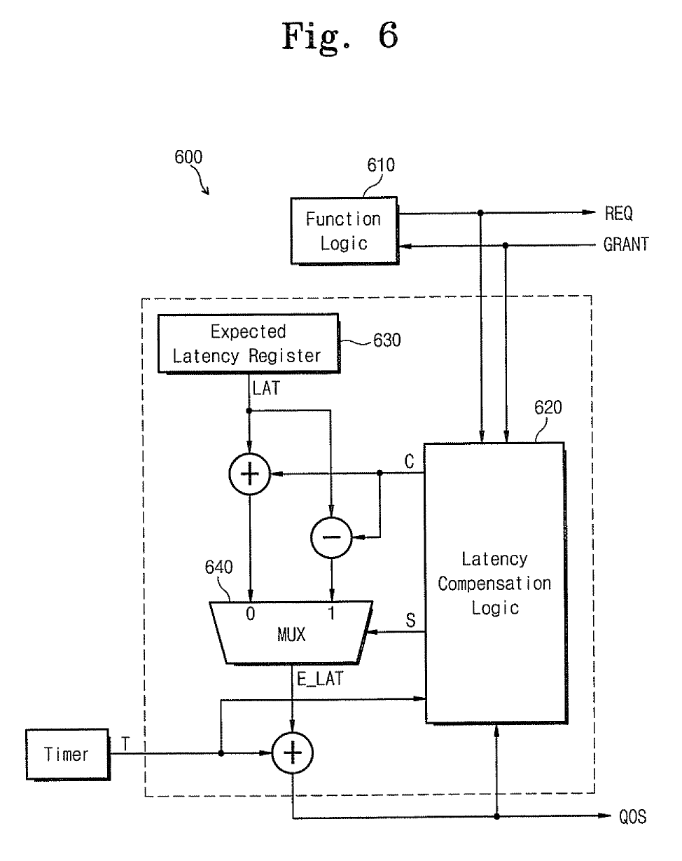

FIG. 6 is a block diagram that illustrates a QoS unit for use in a master or requester unit in accordance with some embodiments of the present invention. A QoS generation unit 600 includes function logic 610, latency compensation logic 620, an expected latency register 630, a multiplexer 640, and a timer 650, which are configured as shown. The following acronyms are used in describing operations of the QoS generation unit 600: LAT—initial expected latency value, which can be set to a pre-determined value in some embodiments; C—latency compensation value; S—expected latency switch control signal; E₁₃ LAT—expected latency value; T—requested time value; QoS—E₁₃ LAT+T; REQ—resource request message as described above; and GRANT—grant message from an arbitration unit as described above.

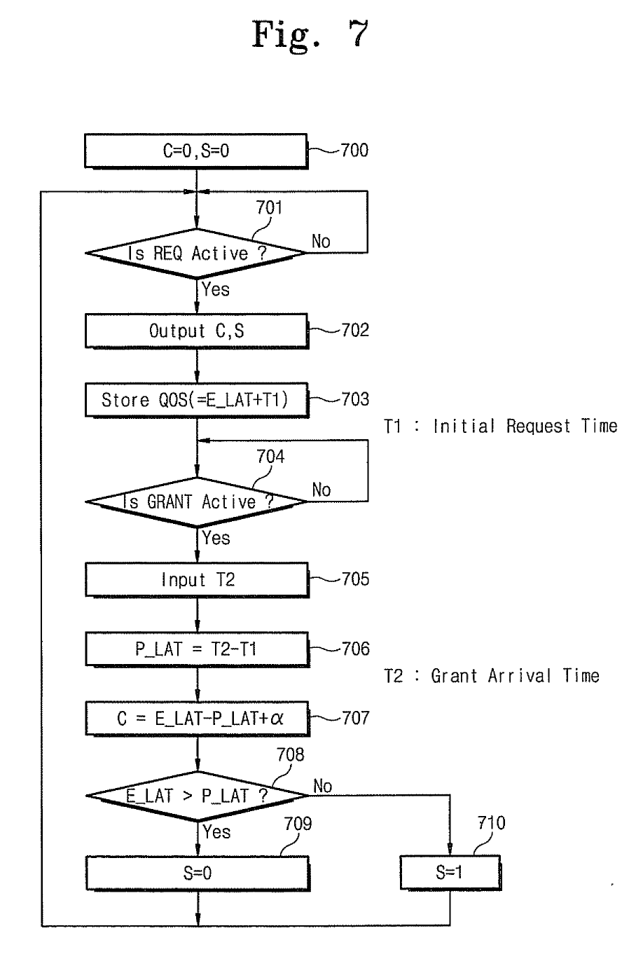

Operations of the QoS generation unit 600, in accordance with some embodiments of the present invention, will now be described with reference to the flowchart of FIG. 7. Operations begin at block 700 where C and S are reset to 0 by the latency compensation logic 630. At block 701, a determination is made whether a REQ is active. If the result is No, then operations remain at block 701. Otherwise, operations continue at block 702 where C and S are output from the latency compensation logic 630. At block 703, the QoS is stored as E₁₃ LAT+T1, an initial request time. At block 704, operations suspend until a GRANT message is received. At block 705, the grant arrival time T2 is noted and a practical latency value P₁₃ LAT is computed as a difference between T2 and T1. As discussed above with respect to FIG. 1, the arbitration unit may send a GRANT message to a master or requestor upon completion of at least a portion of the request associated with the resource request message, upon acceptance of the request associated with the resource request message, or upon completion of the request associated with the resource request message, Thus, in accordance with various embodiments of the present invention, the time T2 may be an arrival time of a resource request message at the arbitration unit or a GRANT message arrival time at the master or requester. For example, if the request is for a write operation on a shared resource, then the time T2 may be an arrival time of the resource write request message at the arbitration unit because the write data can be transferred into the network in advance of or concurrent with sending the resource write request message to the arbitration unit. The write data can be stored in a write buffer, for example, at the arbitration unit. If, however, the request is for a read operation from a shared resource, then time T2 may be the GRANT message arrival time at the master or requestor because the read data can be transferred into the network in advance of or concurrent with sending tile GRANT message to the master or requester.

A latency compensation value is computed as the difference between the expected latency value E₁₃ LAT and the practical latency value P₁₃ LAT. In some embodiments, a weight factor a may be added to the result allowing the ability to tune how fast the expected latency value is reduced or raised for a subsequent resource request message. If the expected latency value exceeds the practical latency value as determined at block 708, then the request was serviced within the QoS requirements. As a result, S is set to 0 so as to choose the expected latency value E₁₃ LAT modified with the addition of the compensation value C for the next resource request message. In this case, the compensation value C is positive thereby having the effect of relaxing the QoS requirement because the previous request was completed early. If, however, the expected latency value does not exceed the practical latency value as determined at block 708, then the request was not serviced within the QoS requirements. As a result, S is set to 1 so as to choose the expected latency value modified by adding the negative C value to the expected latency value for the next resource request message. In this case, the compensation value C is negative thereby having the effect of tightening the QoS requirement because the previous request was not completed within the requested QoS time limit. As stated above, a weight factor α can be used to adjust how fast the expected latency value is modified and, as a result, the QoS request is relaxed or tightened in accordance with some embodiments of tile present invention.

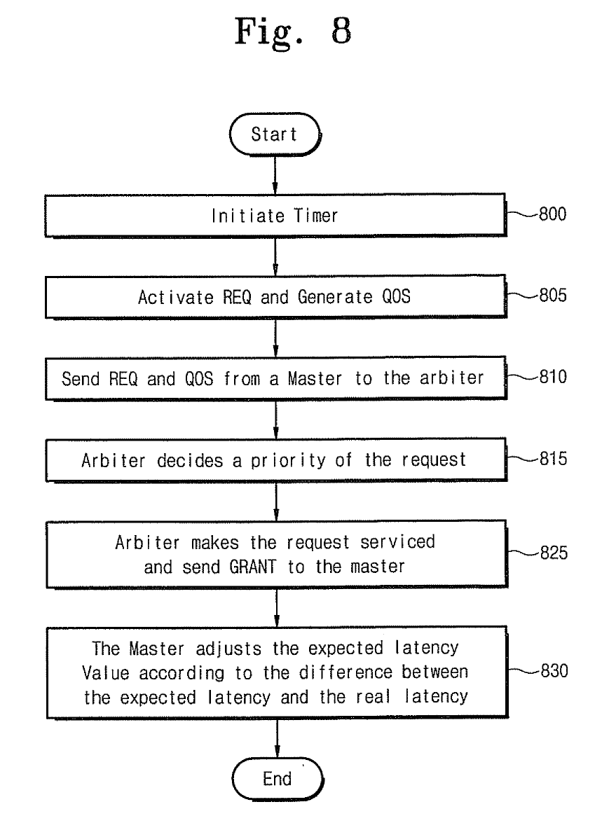

FIG. 8 is a flowchart that illustrates operations of arbitration systems and methods in accordance with some embodiments of the present invention. Operations begin at block 800 where one or more timers are initiated to ensure that the various components, e.g., master/requestor units and the arbitration unit, share a common time reference. At block 805 a requester unit constructs a resource request message that may include QoS information for servicing the request. The resource request message along with the QoS information is sent to the arbitration unit at block 810. The arbitration unit decides the priority of the request with respect to other requests for access to the resource based on the QoS information at block 815. The arbitration unit 820 allows the resource to service the request based on the priority assigned to the request and sends a GRANT message to the requestor that sent the resource request message at block 825. The requestor may adjust the expected latency value for subsequent requests for this resource based on the difference between the expected latency and the actual latency or practical latency experienced in fulfillment of the instant request at block 830.

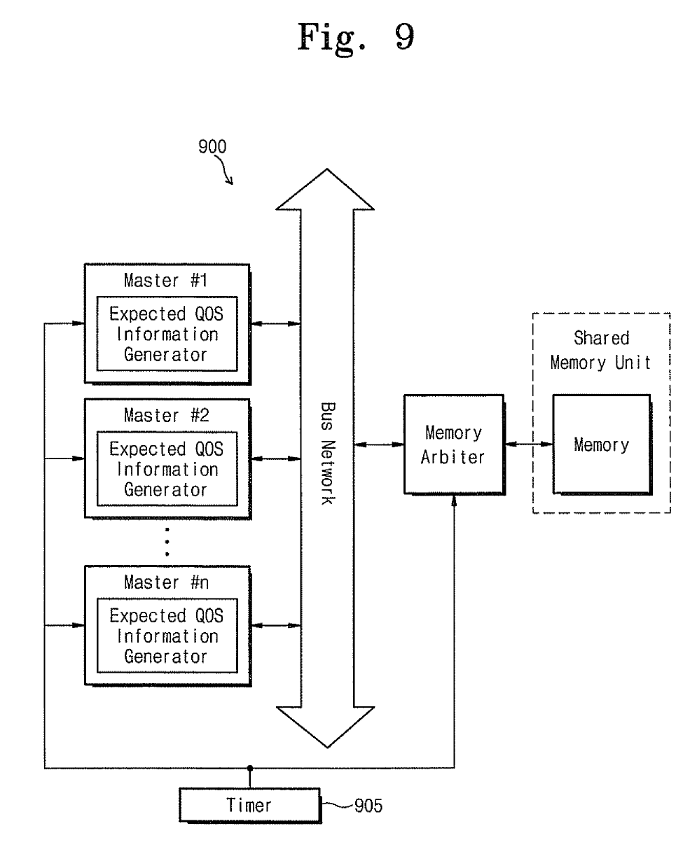

Referring now to FIG. 9, an arbitration system 900 is shown in which the master or requestor units and an arbitration unit all share a common global timer or clock 905. This may be contrasted with the embodiments shown in FIGS. 2 and 3 in which separate timers/clocks are used that are synchronized to ensure that all of the components share a common time reference. By using a global timer or clock, the need to synchronize multiple clocks and timers can be eliminated. The various components of the arbitration system of FIG. 9 and operations thereof are similar to those of the arbitration systems of FIGS. 1 and 2. Although FIG. 9 illustrates an arbitration system for arbitrating access to a memory, it will be understood that the present invention is not limited to such applications, but can instead be embodied generally without regard to the nature of shared device or process.

Advantageously, as described above, some embodiments of the present invention may allow an arbitration unit to control access to a shared resource based on quality-of-service information. Moreover, the quality-of-service information may incorporate the real latency of a bus and/or computer system network that may connect the requestor to the arbitration unit and/or the shared resource.

The flowcharts of FIGS. 7 and 8 illustrate the architecture, functionality, and operations of some embodiments of methods, systems, and computer program products for operating arbitration systems. In this regard, each block represents a module, segment, or portion of code, which comprises one or more executable instructions for implementing the specified logical function(s). It should also be noted that in other implementations, the function(s) noted in the blocks may occur out of the order noted in FIGS. 7 and 8. For example, two blocks shown in succession may, in fact, be executed substantially concurrently or the blocks may sometimes be executed in the reverse order, depending on the functionality involved.

In concluding the detailed description, it should be noted that many variations and modifications can be made to the preferred embodiments without substantially departing from the principles of the present invention. All such variations and modifications are intended to be included herein within the scope of the present invention, as set forth in the following claims.

That which is claimed:

1. An arbitration system, comprising:
at least one shared resource;
a plurality of requestor units, respective ones of the plurality of requestor units being configured to generate a resource request message for accessing the at least one shared resource, the resource request message comprising quality of service (QoS) information; and
an arbitration unit that is configured to prioritize requests for the at least one shared resource based on the QoS information contained in the resource request messages.

2. The arbitration system of claim 1, wherein the QoS information comprises an initial request time and an expected latency time.

3. The arbitration system of claim 2, wherein the QoS information comprises a summation of the initial request time and the expected latency time.

4. The arbitration system of claim 2, wherein the QoS information comprises the initial request time concatenated with the expected latency time.

5. The arbitration system of claim 1, wherein the QoS information further comprises a requested data bandwidth.

6. The arbitration system of claim 1, wherein the plurality of requester units are connected to the arbitration unit through a network.

7. The arbitration system of claim 6, wherein the plurality of requestor units are connected to the arbitration unit through the network via a multi-port interface.

8. The arbitration system of claim 6, wherein the plurality of requester units are connected to the arbitration unit through the network via a single-port interface.

9. The arbitration system of claim 6, wherein the network comprises a computer network, and/or at least one bus network.

10. The arbitration system of claim 1, wherein the arbitration unit comprises at least one buffer for storing resource request messages from the plurality of requestor units.

11. The arbitration system of claim 1, wherein the arbitration unit is further configured to send a grant message to respective ones of the plurality of requestor units upon completion of at least a portion of a request associated with the resource request message.

12. The arbitration system of claim 11, wherein the grant message comprises an arrival time at the respective ones of the plurality of requestor units or an arrival time of the resource request message at the arbitration unit.

13. The arbitration system of claim 11, wherein the arbitration unit is further configured to send the grant message to respective ones of the plurality of requestor units upon acceptance of the request associated with the resource request message by the at least one shared resource.

14. The arbitration system of claim 11, wherein the arbitration unit is further configured to send the grant message to respective ones of the plurality of requestor units upon completion of the request associated with the resource request message.

15. The arbitration system of claim 11, wherein the QoS information comprises an initial request time and an expected latency time, and wherein respective ones of the plurality of requestor units comprise;
a QoS unit that is configured to generate the QoS information, the QoS unit comprising:
latency compensation logic that is configured to determine a compensation value, which is a difference between a time associated with receipt of the grant message and a sum of the initial request time and the expected latency time; and
output logic that is configured to add the compensation value to the expected latency time so as to modify the expected latency time for use in a subsequent resource request message.

16. The arbitration system of claim 15, wherein the QoS information further comprises a requested data bandwidth.

17. The arbitration system of claim 15, wherein the output logic is further configured to arithmetically modify the expected latency time using a weight value.

18. The arbitration system of claim 1, further comprising:
a timer that is commonly used by the plurality of requester units and the arbitration unit.

19. The arbitration system of claim 1, wherein the plurality of requester units and the arbitration unit have a plurality of timers associated therewith, respectively.

20. An arbitration method, comprising:
generating a resource request message for accessing at least one shared resource at a requester unit, the resource request message comprising quality of service (QoS) information.

21. The arbitration method of claim 20, further comprising:
prioritizing requests for at least one shared resource based on the QoS information contained in the resource request message.

22. The arbitration method of claim 21, wherein prioritizing requests comprises prioritizing requests at an arbitration unit, the method further comprising:
sending the resource request message to the arbitration unit over a network.

23. The arbitration method of claim 22, further comprising:
using a common timer for the requestor unit and the arbitration unit.

24. The arbitration method of claim 22, further comprising:
using separate timers for the requestor unit and the arbitration unit, respectively.

25. The arbitration method of claim 22, wherein the network comprises a computer network and/or at least one bus network.

26. The arbitration method of claim 20, wherein the QoS information comprises an initial request time and an expected latency time.

27. The arbitration method of claim 26, wherein the QoS information further comprises a requested data bandwidth.

28. The arbitration method of claim 26, wherein the QoS information comprises a summation of the initial request time and the expected latency time.

29. The arbitration method of claim 26, wherein the QoS information comprises the initial request time concatenated with the expected latency time.

30. The arbitration method of claim 20, further comprising:
sending a grant message to the requester unit upon completion of at least a portion of a request associated with the resource request message.

31. The arbitration method of claim 30, wherein the grant message comprises an arrival time at the requester unit or an arrival time of the resource request message at an arbitration unit that is configured to prioritize requests for the at least one shared resource based on the QoS information contained in the resource request message.

32. The arbitration method of claim 30, wherein sending the grant message comprises:
sending the grant message to the requester unit upon acceptance of the request associated with the resource request message at the at least one shared resource.

33. The arbitration method of claim 30, wherein sending the grant message comprises:
sending the grant message to the requester unit upon completion of the request associated with the resource request message.

34. The arbitration method of claim 30, wherein the QoS information comprises an initial request time and an expected latency time, the method further comprising:
determining a compensation value, which is a difference between a time associated with receipt of the grant message and a sum of the initial request time and the expected latency time; and
adding the compensation value to the expected latency time so as to modify the expected latency time for use in a subsequent resource request message.

35. The arbitration method of claim 34, wherein the QoS information further comprises a requested data bandwidth.

36. The arbitration method of claim 34, further comprising:
arithmetically modifying the expected latency time using a weight value.

37. A computer program product comprising:
a computer readable storage medium comprising computer readable program code embodied thereon, the computer readable program code comprising computer readable program code configured to carry out the method of claim 20.

38. An arbitration system, comprising:
a requestor that is configured to use a resource request message to request access to at least one shared resource, the resource request message comprising an initial request time of the requestor.

39. The arbitration system of claim 38, further comprising:
an arbitration unit; and
wherein the requestor is configured to send the resource request message to the arbitration unit over a network.

40. The arbitration system of claim 39, wherein the network comprises a computer network, and/or at least one bus network.

41. The arbitration system of claim 39, wherein the arbitration unit is configured to determine a network delay based on the initial request time of the requester.

42. The arbitration system of claim 38, wherein the resource request message comprises Quality of Service (QoS) information, the QoS information comprising the initial request time and an expected latency time.

43. The arbitration system of claim 42, wherein the QoS information further comprises a requested data bandwidth.

44. The arbitration system of claim 42, wherein the QoS information comprises a summation of the initial request time and the expected latency time.

45. The arbitration system of claim 42, wherein the QoS information comprises the initial request time concatenated with the expected latency time.

46. An arbitration method, comprising;
using a resource request message to request access to at least one shared resource for a requester, the resource request message comprising an initial request time of the requestor.

47. The arbitration method of claim 46, further comprising:
sending the resource request message from a requester to an arbitration unit over a network.

48. The arbitration method of claim 47, further comprising:
determining a network delay at the arbitration unit based on the initial request time of the requester.

49. The arbitration method of claim 46, wherein the resource request message comprises Quality of Service (QoS) information, the QoS information comprising the initial request time and an expected latency time.

50. The arbitration method of claim 49, wherein the QoS information further comprises a requested data bandwidth.

51. The arbitration method of claim 49, wherein the QoS information comprises a summation of the initial request time and the expected latency time.

52. The arbitration method of claim 49, wherein the QoS information comprises the initial request time concatenated with the expected latency time.

53. A computer program product comprising:
a computer readable storage medium comprising computer readable program code embodied thereon, the computer readable program code comprising computer readable program code configured to carry out the method of claim 46.
